(19) United States
(12) Patent Application Publication
(10) Pub. No.: US 2026/0159427 A1
(43) Pub. Date: Jun. 11, 2026

(54) SYSTEM AND METHOD FOR MONITORING AND CONTROL OF WASTEWATER BIOFILTRATION

(71) Applicant: BIOFILTRO USA, INC., Davis, CA (US)

(72) Inventors: Matías SJÖGREN, Santiago (CL); Sina PRAM, FRESNO, CA (US)

(21) Appl. No.: 18/860,867

(22) PCT Filed: Apr. 28, 2022
(86) PCT No.: PCT/IB2022/053967

§ 371 Date: Oct. 28, 2024

(51) Int. Cl. C02F 9/00; B01F 23/237; B01F 25/312; B01F 101/00; C02F 1/00; C02F 1/66; C02F 3/00; C02F 3/02

(52) U.S. Cl. CPC C02F 9/00; B01F 23/237612; B01F 25/312; C02F 3/006; B01F 2101/305; C02F 1/001; C02F 1/66; C02F 3/02; C02F 2201/005; C02F 2209/003; C02F 2209/008; C02F 2209/02; C02F 2209/03; C02F 2209/05; C02F 2209/06; C02F 2209/10; C02F 2209/40; C02F 2209/42; C02F 2301/043; C02F 2301/046

(57) ABSTRACT

A system and a method for monitoring and controlling wastewater biofiltration are presented. The system is integrated in a wastewater biofiltration system. The wastewater biofiltration system includes a wastewater source that provides a wastewater flow, an equalization unit downstream of the source, a mixing unit, a pumping unit downstream of the equalization unit, a biofiltration unit downstream of the pumping unit, a biofiltered wastewater discharge downstream of the biofiltration unit, a recirculation unit, and at least one controller. Operation of the units is monitored and controlled by the at least one controller and an operational architecture is specially designed to improve biofiltration management.

The invention relates to wastewater biofiltration, in particular, to a system and a method for monitoring and control of wastewater biofiltration. The monitoring and control system and method being integrated in a wastewater biofiltration system comprising a set of units which operation is monitored and controlled by means of at least one controller and an operational architecture specially designed to improve biofiltration management.

### BACKGROUND OF THE INVENTION

Contaminants present in sewage and wastewater include solids, organic matter as well as nutrients such as nitrogen and phosphorus. Physical, biological, and chemical methods are used to remove said contaminants. Among these, biological methods for removing pollutants using bacteria are most economically and efficiently used, and thus are most widely used in the field. Filtering water trough said biological methods is commonly known as biofiltration.

U.S. Pat. No. 7,540,960 (Villagra) discloses a biofiltration technique for treating contaminated water using earthworm's humus to inoculate diverse types of bacteria. As described in said patent, bacteria can be inoculated using different liquid or semi-liquid residues, which when in contact with the humus generate a bacterial flora specialized in degrading the type of liquid or semi-liquid residue that is being used. The ability of worms to compost organic matter has long been known, but there are limitations in connection to the quantity of waste able to be processed, the smell involved when processing organic waste and flow management in the case of wastewater.

The known prior art which uses biological approaches to process wastes requires extensive processing of the waste before biofiltration, and quite frequently requires complementary techniques for improving quality of biofiltered wastewater. Besides, biofilters are overly sensitive to changes in wastewater parameters, like pH, temperature, and total suspended solids (TSS), among others, requiring a continuous management of the wastewater feed to operate efficiently. This usually results in a complex operation and high operational and maintenance cost, which are the main barrier for implementing biofiltration technologies.

Consequently, there is a need for a system and a method specifically designed for monitoring and control of wastewater biofiltration, being integrated in a wastewater biofiltration system that solves the prior art problems.

### SUMMARY OF THE INVENTION

For overcoming the above issues, the invention proposes a system for monitoring and control of wastewater biofiltration, integrated in a wastewater biofiltration system, said wastewater biofiltration system comprising:
a wastewater source, configured to provide a wastewater main flow;
an equalization unit downstream of the wastewater source, configured to receive the wastewater main flow in a controllable manner and to adjust parameters of the wastewater obtaining a wastewater feed suitable for biofiltration, wherein the equalization unit comprises at least one equalization tank comprising:
   at least one wastewater inlet;
   at least one wastewater feed outlet; and
   at least one wastewater level sensor;
a mixing unit, configured to extract a wastewater portion from the equalization unit, measure and adjust parameters of the wastewater portion, and deliver the wastewater portion with adjusted parameters to the equalization unit, wherein the mixing unit comprises:
   a first impulsion subunit;
   at least one pH sensor;
   at least one Total Suspended Solids (TSS) sensor; and
   at least one additive injection location for additive injection from at least one additive source;
a pumping unit downstream the equalization unit, configured to extract the wastewater feed from the equalization unit and deliver the wastewater feed to a biofiltration unit, initiating wastewater feed cycles, wherein the pumping unit comprises a second impulsion subunit and at least one wastewater feed flowmeter;
a biofiltration unit downstream the pumping unit, configured to receive the wastewater feed over at least one biofiltration bed, biofilter the wastewater feed and deliver biofiltered wastewater;
a biofiltered wastewater discharge downstream the biofiltration unit, configured to receive the biofiltered wastewater;
a recirculation unit, configured to extract a biofiltered wastewater portion from the biofiltered wastewater discharge and to deliver the biofiltered wastewater portion to the equalization unit, wherein the recirculation unit comprises at least one recirculation valve and/or a third impulsion subunit, and wherein the recirculation unit further comprises at least one recirculation flowmeter; and
at least one controller in communication with the equalization, mixing, pumping and recirculation units.

The at least one controller of the system is specially designed to control wastewater biofiltration, being configured to:
enable or disable the input of the wastewater main flow to the equalization unit, by means of wastewater level data measured by the at least one wastewater level sensor;
operate the first impulsion subunit based on predefined mixing operation times or based on pH data of the wastewater portion measured by the at least one pH sensor of the mixing unit, wherein the predefined mixing operation times are stored in the at least one controller;
adjust parameters of the wastewater portion extracted by the mixing unit, by the pH data and the operation of the at least one additive injection location;
operate the second impulsion subunit based on predefined wastewater feed operation times, a wastewater feed volume or an absolute value of solids, wherein the predefined wastewater feed operation times are stored in the at least one controller, the wastewater feed volume is obtained by the at least one wastewater feed flowmeter and the absolute value of solids is obtained by means of data from the at least one TSS sensor and the volume delivered by the at least one wastewater feed flowmeter; and
operate the at least one recirculation valve and/or the third impulsion subunit based on a predefined quantity of biofiltered wastewater to be recirculated to the equalization unit and recirculation volume measured by the at least one recirculation flowmeter.

In addition, the invention further proposes a method for monitoring and control of wastewater biofiltration, integrated in a wastewater biofiltration method, said wastewater biofiltration method comprising:
receiving, from a wastewater source, a wastewater main flow in an equalization unit downstream the wastewater source, wherein said equalization unit receives the wastewater main flow in a controllable manner and adjusts wastewater parameters obtaining a wastewater feed suitable for biofiltration, and wherein the equalization unit comprises at least one equalization tank comprising:
   at least one wastewater inlet;
   at least one wastewater feed outlet; and
   at least one wastewater level sensor;
extracting a wastewater portion from the equalization unit by means of a mixing unit, wherein the mixing unit comprises:
   a first impulsion subunit;
   at least one PH sensor;
   at least one Total Suspended Solids (TSS) sensor; and
   at least one additive injection location for additive injection from at least one additive source;
measuring and adjusting parameters of the wastewater portion by the mixing unit;
delivering the wastewater portion with adjusted parameters to the equalization unit,
extracting, from the equalization unit, the wastewater feed by means of a pumping unit downstream the equalization unit, wherein the pumping unit comprises a second impulsion subunit and at least one wastewater feed flowmeter;
delivering the wastewater feed to at least one biofiltration bed of a biofiltration unit, initiating wastewater feed cycles;
receiving the wastewater feed in the biofiltration unit downstream the pumping unit, wherein said biofiltration unit biofilters the wastewater feed and delivers biofiltered wastewater;
receiving the biofiltered wastewater in a biofiltered wastewater discharge downstream the biofiltration unit;
extracting a portion of the biofiltered wastewater from the wastewater discharge by means of a recirculation unit, wherein the recirculation unit comprises at least one recirculation valve and/or a third impulsion subunit, and wherein the recirculation unit further comprises at least one recirculation flowmeter; and
delivering the biofiltered wastewater portion to the equalization unit.

By means of at least one controller in communication with the equalization, mixing, pumping and recirculation units, the method further comprises that the at least one controller:
enables or disables the input of the wastewater main flow to the equalization unit, by means of wastewater level data measured by the at least one wastewater level sensor;
operates the first impulsion subunit based on predefined mixing operation times or based on pH data of the wastewater portion measured by the at least one pH sensor of the mixing unit, wherein the predefined mixing operation times are stored in the at least one controller;
adjusts parameters of the wastewater portion extracted by the mixing unit, by the pH data and the operation of the at least one additive injection location;
operates the second impulsion subunit based on predefined wastewater feed operation times, a wastewater feed volume or an absolute value of solids, wherein the predefined wastewater feed operation times are stored in the at least one controller, the wastewater feed volume is obtained by the at least one wastewater feed flowmeter and the absolute value of solids is obtained by means of data from the at least one TSS sensor and the volume delivered by the at least one wastewater feed flowmeter; and
operates the at least one recirculation valve and/or the third impulsion subunit based on a predefined quantity of biofiltered wastewater to be recirculated to the equalization unit and recirculation volume measured by the at least one recirculation flowmeter.

The wastewater main flow is external to the invention and may came from different wastewater sources like a dairy farm. Therefore, enabling the input of the wastewater main flow means allowing said flow to feed the equalization unit, in particular, allowing said flow to enter the at least one equalization tank from its source. On the other hand, disabling said input of wastewater main flow means stop feeding the equalization unit, for instance, by diverting the wastewater main flow to an external auxiliary pond or sump, shutting down the wastewater main flow from its source or any other applicable mean.

According to an embodiment of the invention, suspended particles greater than a predefined size of suspended particles are removed from the wastewater main flow, by means of a filtration unit upstream the equalization unit. The filtration unit comprises at least one filter, preferably, at least two filters with one of them as a spare part, to avoid stopping the process in case of clogging. Preferably, the at least one filter is a mesh filter, and the predefined size of suspended particles to be removed is of 1-3 mm, which may generate clogging or damage the pumping unit feeding the biofiltration unit or any impulsion subunits like wastewater pumps. Alternatively, the filtration unit comprises at least one filtration pressure sensor, which can be located at the top of the filter for detecting clogging by means of flow pressure changes. The at least one controller is further in communication with the filtration unit and, if the at least one filtration pressure sensor measures a filtration pressure greater than a predefined filtration pressure threshold, under an undesired pressure scenario, the invention further comprises that the at least a controller:
disables the main wastewater flow;
bypasses the wastewater main flow directly to the equalization unit; or
when the filtering unit comprises two or more filters and a first filter has triggered the filtration pressure sensor, activates a redirecting valve that redirects the wastewater main flow to a second filter.

Alternatively, the occurrence of an undesired pressure scenario activates the issuance of an alarm by the at least one controller, said alarm can be a visual alarm trough a known visualization means, like a warning light in a control panel or a wireless message communicated to a User Equipment and/or to a server in a network. Other types of alarms like sound alarms are also implementable. In case of filter failure due to clogging, the clogged filter is cleaned manually, but any applicable solution for automating cleaning can be implemented.

According to an embodiment of the invention, the wastewater level sensor is an ultrasonic sensor or other applicable sensor capable of measuring the instantaneous distance from the highest part of the at least one equalization tank to a wastewater surface inside said equalization tank. Then, the equalization tank may also include:
at least one low level switch;
at least one medium level switch with high and low positions; and
at least one high level switch;

In view of the above, the invention further comprises that the at least one controller:
deactivates the first, second and/or third impulsion subunits if the low-level switch is activated;
enables the wastewater main flow from the wastewater source if the mid-level switch is activated in the low position;
disables the wastewater main flow from the wastewater source if the mid-level switch is activated in the high position; and
disables the wastewater main flow from the wastewater source if the high-level switch is activated.

The combination of level sensors and switches in the at least one equalization tank provides relevant main flow data about the behavior of the wastewater main flow, which can be used to better adapt the operation of the wastewater biofiltration process to the fluctuations of the wastewater main flow form the source. In fact, said main flow data can be used to identify a daily or weekly operational sequence, improving efficiency of the biofiltering process by adapting the different units of the system to the fluctuations of the main flow.

According to an embodiment of the invention, the mixing unit comprises at least one mixing line that is arranged close to a bottom of the at least one equalization tank, preferably, in the lower third of the at least one equalization tank, wherein:
The extraction of the wastewater portion from the equalization tank is conducted in an extraction section of the at least one mixing line, by the first impulsion subunit; and
The measurement and adjustment of parameters of the wastewater portion is conducted in a measurement and adjustment section of the at least one mixing line, wherein the measurement and adjustment section comprises the at least one pH sensor, the at least one TSS sensor and the at least one additive injection location.

Besides, the invention further comprises introducing air to the wastewater portion in an aeration section of the at least one mixing unit, obtaining an aerated wastewater portion; and delivering the portion of wastewater with adjusted parameters and aerated is conducted in an injection section inside the at least one equalization tank. In this case, the mixing unit is designed to improve mixture of additives in the mixing line, delivering or distributing the mixture of wastewater portion and additives inside the at least one equalization tank in the more uniform and homogenous manner. Besides, the mixing unit can incorporate oxygen to the extracted wastewater portion, which is in turn introduced into the at least one equalization tank. The introduction of oxygen is directed to ensuring an aerobic condition of the wastewater to be filtered and improves odor control when deemed necessary. Ultimately, the main aims of the mixing unit are: i) transporting the additives to the wastewater inside the equalization tank before entering the biological process, and ii) preventing decantation of solids inside the equalization tank, keeping solids floating to ensure that they pass to the biological process. In view of the above, the predefined mixing operation times are set to fulfill said main aims of the mixing unit, leading to obtain a uniform wastewater feed from the equalization unit.

Alternatively, the first impulsion subunit is a mixing pump, the aeration section comprises a Venturi device that extracts atmospheric air and the injection section comprises a distribution ring with mixing injectors within the at least one equalization tank. Then, by the Venturi device and the mixing injectors, mixing and distributing the aerated wastewater portion with adjusted parameters within the at least one equalization tank and adding oxygen within the at least one equalization tank are enhanced, obtaining a wastewater feed suitable for an efficient biofiltration. Preferably, the mixing injectors are designed to inject micro or nano bubble into the equalization tank.

According to an embodiment of the invention, the mixing unit further comprises the following features regarding its operation:
the predefined mixing operation times comprise activation and deactivation intervals of the first impulsion subunit, said intervals being of between 7 to 30 minutes, preferably of 10 minutes. Activating the mixing unit introduces a continuous wastewater movement into the equalization tank, improving mixture of the additives and obtaining a constant wastewater feed suitable for biofiltration. However, said approach increases energy consumption. Therefore, the activation and deactivation intervals are the best approach for ensuring obtaining a wastewater feed suitable for biofiltration at the minimum energy consumption.
when the at least one pH sensor measures a pH level lower than 5.5 or greater than 9.0, preferably lower than 6.0 or greater than 8.5, the invention comprises that the at least one controller:
   activates the first impulsion subunit;
   activates the injection of at least one pH regulating additive via the at least one additive injection location; and
   deactivates the second impulsion subunit.

Then, when the at least one pH sensor measures a pH level within the range 5.5-9.0, preferably within 6.0-8.5, the invention further comprises that the at least one controller:
deactivates the injection of the at least one pH regulating additive; and
deactivates the first impulsion subunit with a predefined delay time, to ensure the mixing of the wastewater within the equalization unit with the wastewater portion with adjusted parameters, obtaining the wastewater feed suitable for biofiltration. The predefined delay time can be of between 3 to 7 minutes, preferably of 5 minutes, avoiding that unmixed additive reach the biofiltration unit. When the mixing unit operates injecting the additives into the wastewater portion within said delay time, the pumping unit extraction wastewater from the equalization tank is deactivated, stopping feeding the biofiltration unit.

According to an embodiment of the invention, the measurement and adjustment section comprises:
one or more additional sensors configured to measure electric conductivity (EC), temperature, Oxidation-Reduction Potential (ORP) and/or pressure of the first impulsion subunit; and
additional additive injection locations configured to adjust parameters of the wastewater portion based on odor control and/or larvae and fly control, and/or to supplement bacteria to the biofiltration unit.

According to an embodiment of the invention, that the at least one additive source corresponds to at least one additive tank, preferably, one additive tank for each additive, wherein the at least one additive tank comprises a metering pump that injects at least one additive by the at least one controller, wherein each additive tank comprises at least one additive level sensor that emits alerts regarding an amount of remaining additive. If no additive remains in the additive tanks and the pH level is outside the operational range, the controller can stop operation of the system. The additive tanks can include a stirring device controlled by the controller of the invention, avoiding clogging or decantation of the additive inside the tanks.

According to an embodiment of the invention, the second impulsion subunit corresponds to wastewater feed pumps which quantity and capacity are defined based on a wastewater feed surface of the biofiltration unit, including an additional wastewater feed pump in case of failure. In addition, the at least one controller activates a sequence of activating the wastewater feed pumps alternately for each wastewater feed cycle, based on the predefined wastewater feed operation times, the wastewater feed volume, or the absolute value of solids.

Besides, the pumping unit can comprise at least one wastewater feed pressure sensor downstream each wastewater feed pump. Then, the invention further comprises that the at least one controller deactivates each wastewater feed pump if the at least one wastewater feed pressure sensor measures a wastewater feed pressure greater than a predefined wastewater feed pressure threshold. In addition, the pumping unit can comprise a manifold downstream the at least one wastewater feed pressure sensor. Then, the invention further comprises that the manifold unifies the pressure of the wastewater feed before the biofiltration unit, wherein the manifold comprises a wastewater feed inlet for each wastewater feed pump and an outlet. Finally, the at least one wastewater feed flowmeter of the pumping unit can be arranged at the outlet of the manifold and upstream a wastewater feed line that delivers wastewater feed to the biofiltration unit.

Alternatively, the at least one biofiltration bed comprises at least one moisture sensor, wherein the at least one controller is further in communication with the at least one moisture sensor and,
if a moisture level of the at least one biofiltration bed is greater than a predefined moisture upper threshold, the method further comprises that the at least one controller deactivates the at least one wastewater feed pump and/or closes a respective electrovalve, or
if a moisture level of the at least one biofiltration bed is lower than a predefined moisture lower threshold, the method further comprises that the at least one controller activates the at least one wastewater feed pump and/or opens a respective electrovalve.

According to an embodiment of the invention, the biofiltration unit comprises two or more biofiltration beds. The pumping unit can comprise an independent wastewater feed line for each biofiltration bed, where each line of wastewater feed comprises a wastewater feed pump and a respective electrovalve. Then, the invention further comprises that the at least one controller operates the opening and closing of each electrovalve with a delay time on the activation or deactivation of the respective wastewater feed pump, based on the predefined wastewater feed operation times, the wastewater feed volume, or the absolute value of solids. Preferably, each biofiltration bed is continuously feed with wastewater during 1 to 20 minutes within 1-hour intervals. Then, the alternative of having more than one biofiltration bed allows a sequential feeding of the biofiltration beds within each 1-hour interval, maximizing the wastewater biofiltration during the wastewater feed cycle.

According to an embodiment of the invention, the predefined wastewater feed operation times and setpoints for the wastewater feed volume, and the absolute value of solids are main control parameters defined and stored for each biofiltration bed of the biofiltration unit, for each wastewater feed cycle and for a daily total. The predefined wastewater feed operation times and the setpoints for the wastewater feed volume and the absolute value of solids are the main control parameters, being stored in the at least one controller. Preferably, said main control parameters are modifiable by an authorized user, having access to said controller directly or through a network.

According to an embodiment of the invention, the equalization unit, the mixing unit, the pumping unit, the recirculation unit and the at least one controller are, at least in part, included within a housing named control unit, optionally the control unit comprises a filtration unit within the housing and upstream the equalization unit and, when the equalization tank has a size grater of 1,000 gallons, it can be placed outside the control unit, adjacent to the same. The control unit can be presented as shipping containers of 10, 20 or 40 feet, depending on the size and capacity of the at least one equalization tank. Said control unit is configured to manage: i) the wastewater requirement from source, ii) the preparation and adjustment of the wastewater before biofiltration, iii) the sequence and thresholds of how wastewater is feed to the biofiltration unit, and iv) the flow of biofiltered wastewater that is recirculated or that is discharged to a final discharge point. By means of piping, the control unit can be fluidly connected to the wastewater source, to the biofiltration unit, and to the biofiltered wastewater discharge. This arrangement allows a modular construction of a wastewater biofiltration system, having a single control unit for operating one or more biofiltration beds, which can be located adjacent the control unit or remotely. Besides, by means of this modular configuration it is possible to add biofiltration beds as separate units, if necessary, which is useful if the wastewater main flow from source increases and more biofiltration capacity is required.

Alternatively, the control unit further comprises at least one fan arranged on a roof of the housing, insulating elements arranged on walls of the housing, at least one heating device and/or at least one access door, generating an independent unit than can be easily constructed, transported, and installed. In fact, the electronics in the control unit, mostly related to the at least one controller, sensors, and actuators, can be energized connected to the grid, generators and/or solar panels. Overall, the system has a low energy consumption.

According to a preferred embodiment of the invention, the biofiltration units is based on biofiltration beds having worms as biofiltering means, and the at least one controller is configured to set wastewater parameters based on biofiltration using worms. Then, the invention catalyzes the digestive power of worms and microbes to rapidly filter out wastewater contaminants. Wastewater, applied intermittently to the biofiltration unit, percolates down through various medias where contaminants are trapped and digested by a biofilm. As worms burrow in search of solids, they create channels which aerate the system while their microbial rich castings propagate and nourish the microbial colonies consuming dissolved and soluble contaminants. When the wastewater hits the biofiltration unit floor, it drains out via exit pipes and can be reutilized for agricultural irrigation or discharged to sewers at reduced contaminant levels. The only thing left behind is a valuable byproduct: worm casting compost.

Among the advantages of the invention, it is important to highlight that it can operate year-round or seasonal, it is custom designed and scalable, it involves a four-hour biofiltering process, properly adjusted is mostly odorless and it has a low energy consumption, of 0.007 kWh per filtered gallon.

### BRIEF DESCRIPTION OF THE FIGURES

FIG. 1 shows a flowchart of an embodiment of the method and system of the invention.

FIG. 2 shows a schematic diagram of an embodiment of the control unit of the invention.

FIG. 3 shows a schematic diagram of a first embodiment of the wastewater biofiltration system of the invention.

FIG. 4 shows a schematic diagram of a second embodiment of the wastewater biofiltration system of the invention.

FIG. 5 shows a schematic diagram of a third embodiment of the wastewater biofiltration system of the invention.

FIG. 6 shows the general overview HMI display of the example of the invention.

FIG. 7 shows the pump control HMI display of the example of the invention.

FIG. 8 shows the pH control HMI display of the example of the invention.

FIG. 9 shows the HMI display with cycle and daily operation restrictions of the example of the invention.

### DESCRIPTION OF PREFERRED EMBODIMENTS

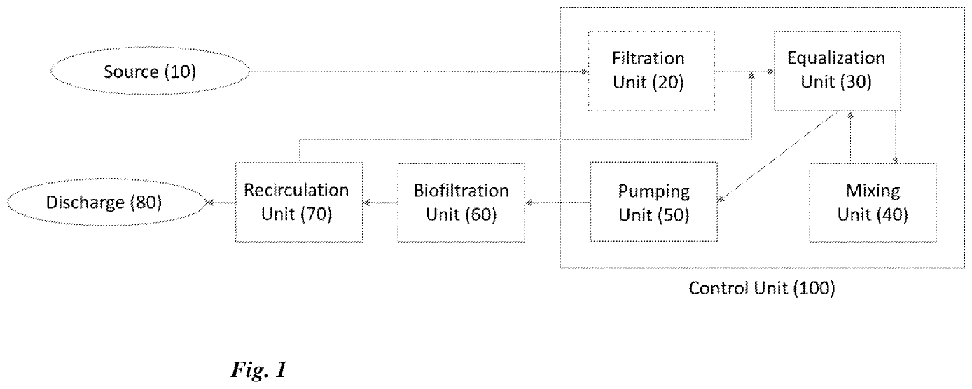

FIG. 1 shows a general flowchart of the main embodiment of the method and system of the invention. According to FIG. 1 the system and its operation (method) comprises: a wastewater source (10); an equalization unit (30), receiving a wastewater main flow from the source (10); a mixing unit (40), extracting/delivering a wastewater portion from/to the equalization unit (30); a pumping unit (50), extracting a wastewater feed from the equalization unit (30); a biofiltration unit (60), receiving the wastewater feed from the pumping unit (50); a recirculation unit (70) for recirculating a portion of the biofiltered wastewater; and a biofiltered wastewater discharge (80). Optionally, the system also contemplates a filtration unit (20) downstream the source (10) and upstream the equalization unit (30). As shown in FIG. 1, the combination of the equalization unit (30), mixing unit (40), pumping unit (50) and, optionally, filtering unit (20) represent the so-called control unit (100), which can be materialized as an enclosure comprising all said units (20, 30, 40, 50).

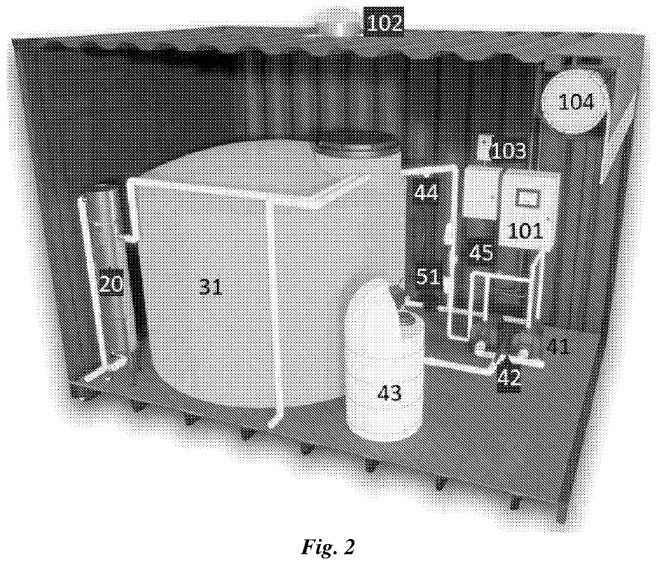

FIG. 2 shows a schematic diagram of an embodiment of the control unit (100), in which the following components are enclosed: an optional filtration unit (20); an equalization tank (31); a first impulsion subunit (41) or pumps of the mixing unit; pH and TSS sensors (42); an additive source (43); an additive injection location (44); an optional Venturi device (45); a wastewater feed flowmeter (51); a controller or PLC (101) in an enclosure; an optional overhead light and/or ventilation fan (102); an optional camera (103) and an optional access door or gate (104).

The control unit of FIG. 2 is presented as a shipping container, which size can be of 10, 20 or 40 feet, depending on the size and capacity of the at least one equalization tank. For instance, a control unit with a single equalization tank can be designed to process of up to 4,000 Gallons Per Day of wastewater. If larger volumes need to be processed, additional equalizations tanks might be required, which can be installed inside the control unit or, if required, arranged outside an existing control unit.

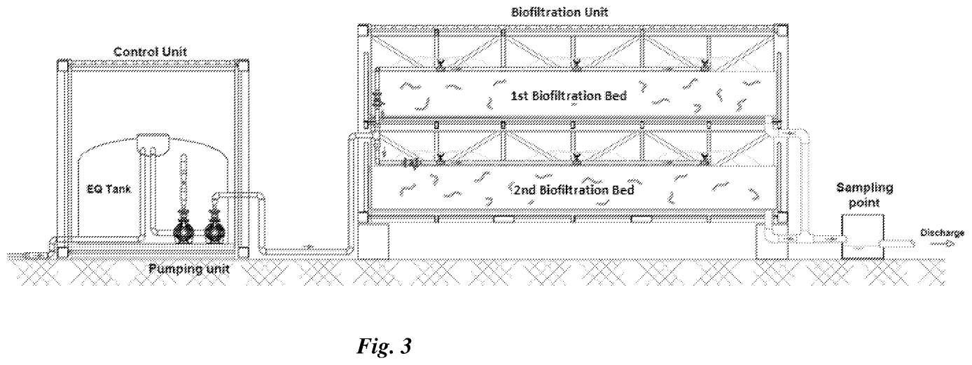

FIGS. 3, 4 and 5 show three installation embodiments of the wastewater biofiltration system of the invention, including a control unit as in FIG. 2 and biofiltration beds housed in a shipping container forming a movable biofiltration unit. The first embodiment in FIG. 3 shows the control unit with an equalization tank (EQ tank) inside, fluidly connected to the pumping unit, said pumping unit fluidly connected to a biofiltration unit formed by two biofiltration beds connected in parallel and vertically staked one over the other. Then, by means of controlling the opening and closing of respective electrovalves upstream the biofiltration beds, different feeding configurations can be implemented. For instance, if there is a need of increasing the biofiltering capacity, the two beds can be feed simultaneously, operating in parallel. On the other hand, under regular operation it would be preferred to operate the two biofiltration beds alternately, operating sequentially.

As can be seen, the embodiment of FIG. 3 clearly shows that the biofiltration system can be modular, comprising a control unit fluidly connected to a biofiltration unit, both units presented as enclosures containing the essential components of the same, respectively. This arrangement is highly advantageous, allowing easy installation and adaptation to the industry wastewater processing requirements.

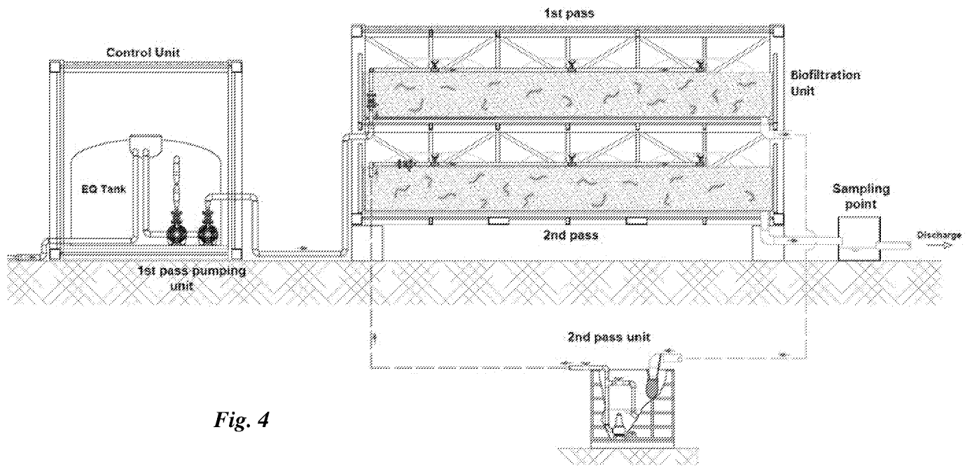

According to the embodiment of FIG. 3, an optional sampling point can be implemented downstream the biofiltration unit, for evaluating the biofiltration behavior or testing the biofiltered wastewater. Notwithstanding this, the data retrieved from the wastewater portion extracted by the mixing unit inside the control unit, which is processed inside the control unit by the controller, is the essential input required by the system and method of the invention to adjust the wastewater feed as required by the biofiltering process. The embodiment of FIG. 4 comprises the same configuration of control and biofiltration units of FIG. 3, but with a different arrangement of the biofiltration beds housed by the biofiltration unit. In FIG. 4 the first and second biofiltration beds are arranged in series, wherein the wastewater feed from the pumping unit is directed to the first biofiltration bed for a first biofiltering pass and then the biofiltered wastewater from the first biofiltration bed is directed to the second biofiltration bed for a second biofiltering pass prior to discharge. As shown in FIG. 4, the second pass can be managed by a second pass unit, in charge of receiving the biofiltered wastewater from the first pass and feeding said biofiltered wastewater to the second biofiltration bed. Said second pass unit can be formed by a vessel or tank of similar purpose of the EQ tank, having an impulsion subunit for feeding the second pass to the second biofiltration bed.

The arrangement of the wastewater system of FIG. 4, in which at least two biofiltration processes are performed, is suitable for improving biofiltration and/or for implementing two different biofiltration approaches. For instance, the first biofiltration bed can be based on vermifiltration with a population of earthworms and bacteria adapted to process wastewater with coarse solids, and the second biofiltration bed can be based on vermifiltration with earthworms and bacteria adapted to process wastewater with fine solids. Besides, the second pass unit can include a filter and other components to adapt the received biofiltered wastewater to the required conditions of the second biofiltration bed. The filtration time of each biofiltration bead (residence time of wastewater in the biofiltration bead) is usually between 1 to 4 hours. The filtration time varies according to the design of the biofiltration bead, for instance, in biofiltration beds based on earthworms and bacteria inoculated in a medium of cellulosic particles, said time mostly depends on the height of the biofiltration bead and size of the cellulosic particles (fine sawdust, wood shavings, wood chips, almond shells, among others).

Similar to FIG. 3, the embodiment of FIG. 4 can include a sample point for testing the quality of the biofiltered wastewater after the biofiltration unit.

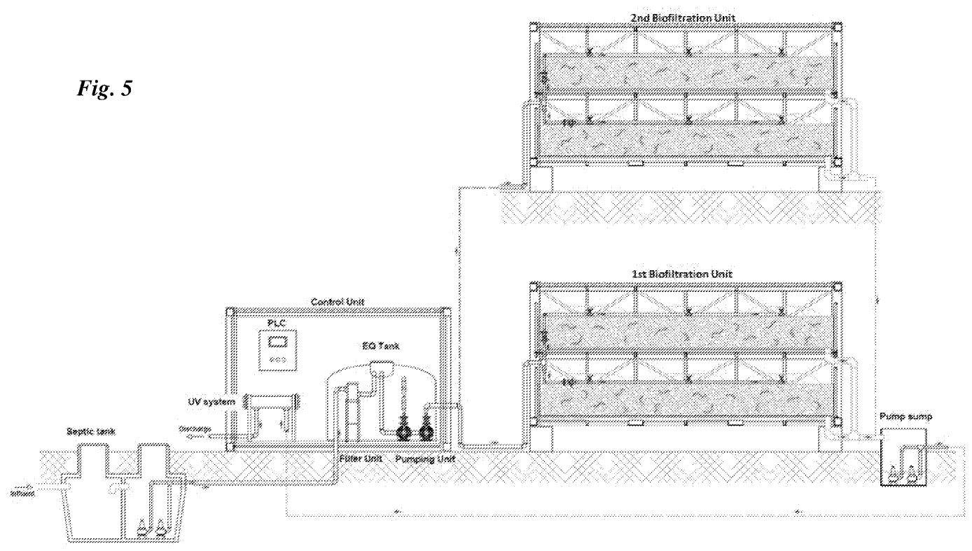

Finally, the embodiment of FIG. 5 represents a wastewater biofiltration system comprising a septic tank as a wastewater source. In this case, the control unit comprises the controller (LCT), a filter representing the filtration unit, an EQ tank representing the equalization unit and two pumps representing the pumping unit.

A wastewater main flow from the septic tank is received by the filter unit for removal of coarse solids from said main flow. Then, the filtered main flow is received by the EQ tank, for obtaining a wastewater feed suitable for biofiltration. Said wastewater feed is pumped to the biofiltration unit by the pumping unit. In this embodiment, the biofiltration system comprises two biofiltration units, each having two biofiltration beds. The two biofiltration units are arranged in parallel and can be connected or disconnected from the system depending on the biofiltration requirements.

As shown in FIG. 5, the biofiltration system can also implement a pump sump connected to the discharge of the biofiltration units, redirecting the biofiltered wastewater to further processing, in this case to a UV system in the control unit, implementing an UV treatment to disinfect the biofiltered wastewater stream, inactivating bacteria in said stream. Other further processing units can be implemented to the biofiltration system, preferably housed in the control unit as in FIG. 5.

The wastewater biofiltration system and method of the invention, integrating the system and method for monitoring and control wastewater biofiltration with an operational architecture specially designed to improve biofiltration management, optimize the operational parameters of the biofiltering process, achieving better efficiencies with enhanced treatment capacities when compared to common biofiltration systems. Table 1 shows the removal efficiencies of the invention, evaluated over the discharge, including data about biological oxygen demand (BOD5), Total Suspended Solids (TSS), Nitrogen (Total Kjeldahl Nitrogen, TKN), Ammonia and Phosphorus.

TABLE 1
Removal Efficiencies

| | |
|---|---|
| BOD5 | 85-99% |
| TSS | 85-99% |
| TKN | 40-99% |
| Ammonia | 60-99% |
| Phosphorus | 35-95% |

In addition, by the invention, the treatment capacity of the biofiltering process is increased, presenting an average treatment capacity as show in Table 2, depending on the BOD5 of the wastewater main flow from the source, or influent.

TABLE 2
Average treatment Capacity

| Influent BOD5 [mg/l] | Gallons Per Day |
|---|---|
| 0-≤500 | ≤2,000 |
| 500-≤1,000 | ≤1,500 |
| 1,000-≤6,000 | ≤600 |
| >6,000 | ≤300 |

Finally, the biofiltration unit operated by the system and method of the invention can be specially designed to enhance the biofiltration process and to propose a modular configuration capable of increasing the treatment capacity as shown in FIG. 5, taking advantage of the monitoring and control capabilities of the invention. Table 3 shows the specification of each biofiltration unit of FIG. 5, specially designed to enhance earthworm and bacteria biotreatment capabilities during wastewater biofiltration.

TABLE 3
Biofiltration Unit Specifications

| | |
|---|---|
| Treatment Capacity | Varies by influent/effluent water quality, but most wineries and food |
| | processors will have a maximum daily capacity of 1,200 gallons. |
| Effluent Water Quality | Single Pass design targets 90%+ contaminant removal while Double |
| | Pass design targets 99%+ removal |
| Influent Concentrations | BOD: 0-1 kg/m²; TSS 0-0.30 kg/m². Total Ammonia (NH3+) 0-0.075 |
| (per day) | kg/m²; Fats, Oil and Grease: 0-0.025 kg/m² |
| Worm Castings Generation | 10 cubic yards per unit every~18-36 months |
| Energy Demand | 0.0007 kWh/gal = 0.84 kWh to treat 1,200 gallons per day. |

The influent concentrations of the biofiltration unit can be set as additional control parameters, for instance, by means of alarms alerting if the wastewater feed is meeting biofiltration design parameters. Other control parameters can be used, like temperature, Oxidation-reduction Potential (ORP) and electric conductivity/conductance, wherein the temperature of the wastewater feed should be of up to 45° C., the ORP should be within the range of −400-+200 mV, preferably above-150 mV, and the electric conductivity of the wastewater feed can be within 0-20 mS/cm.

The configuration of the biofiltration unit as a movable unit as shown in FIGS. 3, 4 and 5 substantially increases the versatility of the biofiltration system, allowing multiple arrangements in which the control unit and one or more biofiltration units are fluidly connected through piping.

### Example

The invention has been tested implementing the control architecture in a vermifilitration biofiltration system at Marlborough Vintners, New Zealand.

The at least one controller is a Programmable Logic Controller (PLC) with modular cards and connection via cellular VPN modem with Ethernet. A Human-Machine Interface (HMI) display is connected to the PLC to display the operation data of the system. The PLC can communicate the operation data to a cloud server via a VPN Router and can communicate with other devices utilizing a Modbus protocol (RS-232, RS-485, TCP), Ethernet/IP, or remote I/O on its remote port for integration or collaboration.

The system is automated using input feedback Proportional Integral Derivative (PID) control parameters such as pH, EC, TSS, temperature and flow monitoring to feed a precise amount of wastewater/loading to the biofiltration beds. Any abundance of the aforementioned parameters is detrimental to the overall health of the biofiltration beds and its worm inhabitants. Therefore, the system will smartly adjust irrigation dynamically with changing wastewater concentrations. All data are routinely transmitted to the cloud server for monitoring and storage. All data can be archived in the cloud for 7 years. Up to 1,000 data points are logged every hour.

### PLC: General Concepts

The PLC represents the brain of the system, including predefined settings involving main and secondary control parameters of the invention.

The PLC receives data from all sensors implemented in the biofiltration process, like pH sensors and flowmeters, and actuates the operation of the biofiltration process through control signals to operate mostly motorized valves (electrovalves) and motorized pumps (impulsion subunits or pumps).

When controlling the motors of valves and pumps, it is important to highlight that all motors in this example utilize a DOL (Direct Online) starter scheme. It is a combination of MMP (Manual Motor Protection), and a contactor inside of a power panel for calling a motor energize and de-energize. The MMP can be locked out utilizing a LOTO (Lock Out Tag Out) locking system. The MMP has a feedback aux contact for the PLC to recognize that a fault or disconnect has occurred on motor control motor circuit. This feedback allows the PLC to issue a fault/disconnect alert and bypass this motor in its automation routine.

All motor also has a field disconnecting means near and insight of the motor. The LOTO system should be utilized here as a means of disconnecting and servicing a motor. The MMP should also be switched to disconnect to alert the PLC that the motor is offline.

A motor tri-state button is included through the HMI display but is not a disconnect or lock out button. It has not function to lock out a motor. Physically disconnection as mentioned above is mandatory.

Besides, the PLC is connected to ta HMI display to allow configuration of the operation parameters and can communicate all information to a user interface remotely.

Additional details of the PLC and its operation are explained in connection to the definition of the HMI and user interactions.

### HMI: General Concepts

The operation data can be displayed trough the HMI, providing uncluttered information at a glance.

The HMI of the invention is an interface capable of displaying all operational data of the system and method, and it is the main platform for monitoring and control of the biofiltration process. In this example, the HMI provides three levels of interaction, as follows:
Level 1: Overview Display, providing a general overview of the operational data, showing information and trends as to the health of the biofiltration system. Provides a clear and easy to understand input to technicians about the operation and health of the system.
Level 2: Process Unit Control Display, providing a detailed overview of specific operational data.
Level 3: Process Unit Limit Stops, providing access to specific settings related to wastewater feed cycles and daily totals, setting the operational parameters for feeding of the biofilter beds of the biofiltration system.

### HMI Display: Tanks

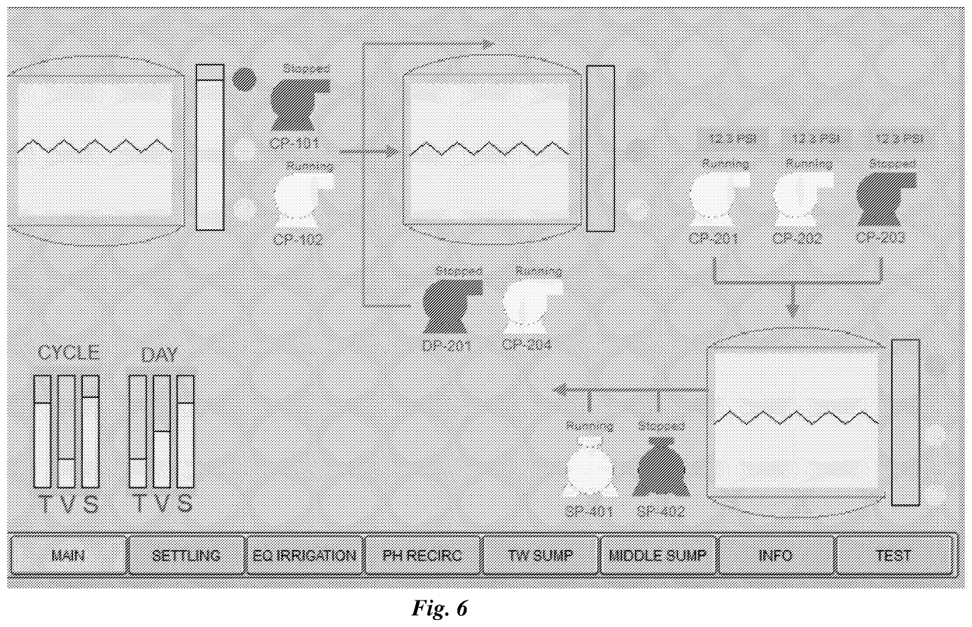

FIG. 6 shows a level 1 display of the HMI, in which three tanks, vessels or sumps are presented. A first tank represents a settling tank, vessel, or sump, as the wastewater source. The second tank represents the equalization tank, being feed from the source with two pumps operating alternately. The third tank represents treated water sump, being feed by three pumps after the biofiltration unit.

Through the HMI, Tanks, Vessels and/or Sumps represented in the system have trends lines for showing the level over a period of time, as shown inside each tank, vessel, or sump in FIG. 6. The trend lines help to identify the rate over time of filling and drawing down wastewater from a vessel and or two a vessel. In FIG. 6 it is possible to note that a bar graph representing the current level inside each tank, vessel or sump is shown to the right of the trend lines (right side of the represented tank, vessel, or sump).

In this case, the level inside one tank is represented by means of level switch indicators, like a float switch indicator, representing the operation of the low, mid, and high-level switches, wherein said switches can be float switches. In FIG. 6 the sets of three floats switches (Low, Mid/Control and High) are represented by three dots at the right of the bar graphs. As shown in FIG. 6, the dots are colored as an indication of the level inside each tank, vessel, or sump, as follows:
Gray—The float is in the Down position
Light Blue—The float is in Up position
Red—Attention is needed, the high float is in the Up position. Overflow may occur.

Besides, each impulsion subunit (pump) is represented by a dynamic pump object. When the pump is ON/Energized/Running it is shown with a white color and the word “Running” appears above. When the pump is Off/De-Energized/Stopped it is shown with a gray color and the word “Stopped” appears appear above. Said configuration is shown in FIG. 6.

Level controls of the sumps, tanks, and/or vessels are done by two kinds of sensors. Discrete flow switches (Low, Mid and High floats described above) and analog ultrasonic level sensors. All float switches are NO (normally opened), and the operation is as follows:
Float Down—Opened contact.
Float UP—Closed contact.
Low float switches—Prevents pumps from running dry.
Mid/Control float switches—Used to require wastewater from source to fill up or drawdown depending on the function of the pumps.
High float switches—Shut down a pump to prevent overfilling a vessel or calling a pump to fill up a tank.

The float switches contemplate fuse state feedback for set of floats, which monitors if the control power common which feeds the floats has a blown fuse. This prevents a false positive on the series of floats switches should this fuse be blown.

On the other hand, Ultrasonic Level Sensors (ULS) are not used for process controls at startups. They are however used for level monitoring and logging. However, when averaging and logging confirms ULS are good in a given location, providing reliable real-time tank level data, they will be brought to control pumps, and the float switches will move to secondary backups. In this case, all ultrasonic sensors are of Flowline DL-24-00 model. Utilizing a portable storage means, like a USB fob, an onsite operator can calibrate the ULS through a software.

Finally, when a treated water sump is implemented, as in this case, the treated water sump is a draw down sump with one or more pumps (two pumps as represented in FIG. 6). The low-level float switch is the lead float switch. This will turn ON one pump at a time. The mid-level float switch is the lag float and call for the second pump to turn ON if activated.

In normal operating condition the low-level float switch alternates between pumps if both sump pumps are in AUTO mode.

The high-level float switch will give an alarm and stop wastewater feed from sending more water to the treated water sump. Once the high-level float has been cleared, the wastewater feed cycle can continue.

### Pump Logic (HMI and Operation)

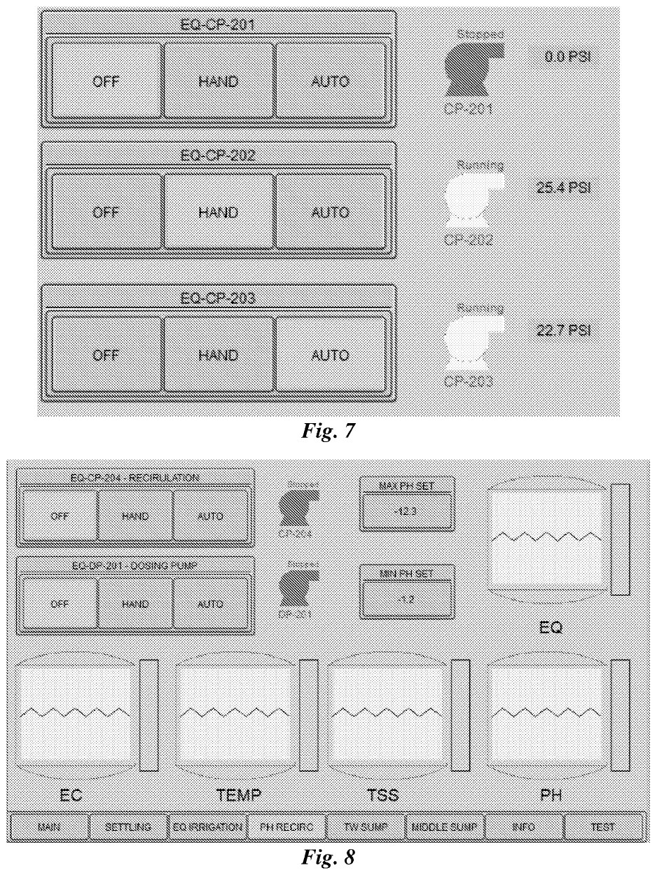

All controls of impulsion subunits or pumps are on level 2 screens of their respective location block in the HMI. A tri-state button of the motor control represents the three states in which a pump can be placed in, as shown in FIG. 7.
OFF—The pump is in its OFF mode. The pump is OFF and de-energized.
HAND—The motor is in Manual Mode. The pump is ON/energized/running. All floats and operational architecture can be ignored.
AUTO—The pump is in Automatic Mode. The pump can be turned on by the PLC intermittently. Caution must be taken as the pump can and will turn on at any given time without notice.

The pumps feeding the equalization unit from source, in this case, from an external settling tank, are controlled as follows:
The call for wastewater signal from the settling tanks or wastewater source to the equalization tank is established when either of the equalization tank low or mid switches is in the down position.
The drawdown of the settling tanks is priority, while the fill up of the equalization tank is secondary.
To prevent the overflow of the settling tanks, at high switch level or ultrasonic level the pumps will send water to the equalization tank.
Overflow of equalization tank is possible when settling tank is full.
Pump alternate when the control parallel pumps is set to AUTO, each pump will alternate pumping to the equalization tank when the call for water signal by the equalization tank mid/control float in its down position and a fill cycle has occurred before.

The impulsion subunit or pump of the recirculation unit will turn on and off periodically according to the following conditions.
During an equalization tank fill from the settling tank, and 5 minutes off delay after the last call for equalization tank fill or pH below or above a range of set points during fill and delay period.
Periodically defined by last recirculation trailing edge. Normally 10 minutes OFF and 10 minutes On. The operation time presets for the impulsion subunit of the recirculation unit represent the predefined quantity of biofiltered wastewater to be recirculated to the equalization unit.

### Pump Logic: PH Adjustment

When the pH adjustment system comprises a pH pump controlling the at least one additive being injected to the wastewater portion in the mixing unit, the system can inject a caustic or acid additive to bring the pH withing a defined range. The initial preferred pH set range is 6.0 to 8.5. This range can be set using the HMI, in this case, under PH RECIRC page of the HMI, as shown in FIG. 8. According to this example, the pH injection system will not initiate if the recirculation pump is not active. The PLC monitors that the recirculation pump is energized and ON by monitoring the status of the associated motors.

FIG. 8 also shown a representation of the equalization tank (EQ) with trend lines inside. Besides, the same tank is represented in connection to the trend lines representing the electric conductivity (EC), temperature (TEMP), Total Suspended Solids (TSS) and pH (PH) as measured by the system, when applicable.

### Pump Logic: Irrigation or Wastewater Feed

In this case, the pumping system feeding the biofiltration unit is formed by three wastewater feed pumps.

When all three pumps are set into AUTO, the pumps will alternate with two pumps ON and one pump OFF every wastewater feed cycle (see FIG. 6). When two pumps are on AUTO both pumps will feed every cycle. The system works on a 2+1 pump configuration. Normally, wastewater feed cycles occur at the top of each 1-hour interval and at 30 minutes pass the 1-hour interval.

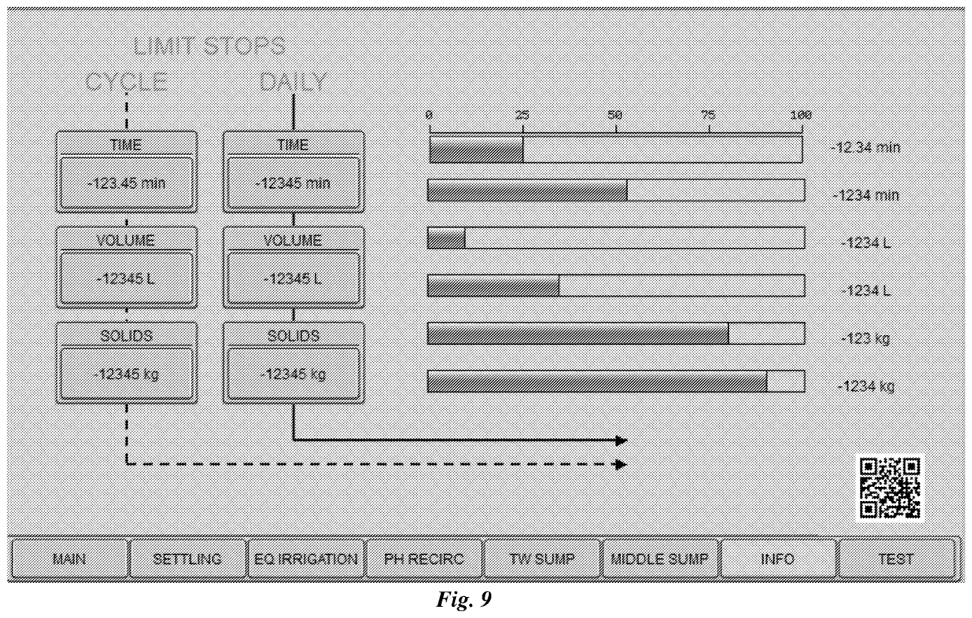

The wastewater feed is defined by restrictions or operational limits of the invention, which are represented by the predefined wastewater feed operation times and setpoints for the wastewater feed volume and absolute value of solids, as set in the INFO screen of the HMI, for each cycle and for a daily total (see FIG. 9).

Predefined wastewater feed operation times: Every cycle has a maximum amount or limit of time the wastewater feed pump can run for. Likewise, there is a daily accumulated maximum or limit amount of time the wastewater feed pump can run for. The component responsible for monitoring said maximum amounts or limits is a timer and a RTC (real time clock) in the PLC.

Preferably, each biofiltration bed is continuously feed with wastewater during 1 to 20 minutes within 1-hour intervals (cycle). The predefined operation time can be set depending on the design of the filtration system and operational conditions, like ambient temperature.

Wastewater feed volume: Each cycle has a maximum or limit volume of wastewater the wastewater feed pump can feed. Likewise, there is a daily accumulated maximum or limit volume of wastewater the wastewater feed pump can feed. Said maximum volumes are defined as setpoints for the wastewater feed volume. The component responsible for obtaining the data related to said setpoints and allowing the monitoring of said limits is the at least one wastewater feed flowmeter of the biofiltration unit, giving a pulse signal to the PLC.

Absolute value of solids: Every cycle has a maximum amount or limit of suspended solids each biofiltration bed can receive. The wastewater feed ceases for the cycle when the measured total suspended solids value has reached the absolute value of solids setpoint for each cycle. Likewise, there is also a daily limit setpoint for solids. Wastewater feed for the day stop once this daily limit is reached. For every liter, the total solid load is calculated based on the TSS concentration of the TSS sensor. The mass of this solids is added to each cycle and daily, registering totalized solid loads.

According to an embodiment of the invention, the daily limit setpoint can be defined as any value, preferably up to 0.3 kg per square-meter of the biofiltration beds (effective processing area of the beds), selected depending on the design of the biofiltration system.

### Limits Monitoring and Control

In the HMI, the restrictions defined above are represented using the term “TVS”, for “Time”, “Volume” and “Solids” (see FIG. 6), which are the three main limiting stop factors for the wastewater feed control system. In the Level 1 Overview Main Screen, in the lower left corner of the HMI (FIG. 6) is the TVS bar graphs. It will display in real time percentage left for the current cycle, or of the last completed cycle. Whichever is current. The daily bar graph will display the current percentage of Total Time, Volume, and Solids as a percentage of its daily limit.

The Level 3 INFO Screen of the HMI also display the same TVS bar graphs, with a larger resolution (see FIG. 9). These limit factors can be set according to a wastewater filtration contract and can be passcode locked. Remote monitoring will keep track of when these parameters are changed and who changed them. Access is strictly limited.

1. A system for monitoring and control of wastewater biofiltration, integrated in a wastewater biofiltration system, the wastewater biofiltration system comprises:
a wastewater source, configured to provide a wastewater main flow;
an equalization unit downstream of the wastewater source, configured to receive the wastewater main flow in a controllable manner and to adjust parameters of the wastewater obtaining a wastewater feed suitable for biofiltration, wherein the equalization unit comprises at least one equalization tank comprising:
at least one wastewater inlet;
at least one wastewater feed outlet; and
at least one wastewater level sensor;
a mixing unit, configured to extract a wastewater portion from the equalization unit, measure and adjust parameters of the wastewater portion, and deliver the wastewater portion with adjusted parameters to the equalization unit, wherein the mixing unit comprises:
a first impulsion subunit;
at least one pH sensor;
at least one Total Suspended Solids (TSS) sensor; and
at least one additive injection location for additive injection from at least one additive source;
a pumping unit downstream the equalization unit, configured to extract the wastewater feed from the equalization unit and deliver the wastewater feed to a biofiltration unit, initiating wastewater feed cycles, wherein the pumping unit comprises a second impulsion subunit and at least one wastewater feed flowmeter;
a biofiltration unit downstream the pumping unit, configured to receive the wastewater feed over at least one biofiltration bed, biofilter the wastewater feed and deliver biofiltered wastewater;
a biofiltered wastewater discharge downstream the biofiltration unit, configured to receive the biofiltered wastewater;
a recirculation unit, configured to extract a biofiltered wastewater portion from the biofiltered wastewater discharge and to deliver the biofiltered wastewater portion to the equalization unit, wherein the recirculation unit comprises at least one recirculation valve and/or a third impulsion subunit, and wherein the recirculation unit further comprises at least one recirculation flowmeter; and
at least one controller in communication with the equalization, mixing, pumping and recirculation units, configured to:
enable or disable the input of the wastewater main flow to the equalization unit, by means of wastewater level data measured by the at least one wastewater level sensor;
operate the first impulsion subunit based on predefined mixing operation times or based on pH data of the wastewater portion measured by the at least one pH sensor of the mixing unit, wherein the predefined mixing operation times are stored in the at least one controller;
adjust parameters of the wastewater portion extracted by the mixing unit, by the pH data and the operation of the at least one additive injection location;
operate the second impulsion subunit based on predefined wastewater feed operation times, a wastewater feed volume or an absolute value of solids, wherein the predefined wastewater feed operation times are stored in the at least one controller, the wastewater feed volume is obtained by the at least one wastewater feed flowmeter and the absolute value of solids is obtained by means of data from the at least one TSS sensor and the volume delivered by the at least one wastewater feed flowmeter; and
operate the at least one recirculation valve and/or the third impulsion subunit based on a predefined quantity of biofiltered wastewater to be recirculated to the equalization unit and recirculation volume measured by the at least one recirculation flowmeter.

2. The system of claim 1, further comprising a filtration unit upstream the equalization unit, wherein the filtration unit comprises at least one filter configured to remove suspended particles larger Flo a predefined size of suspended particles from the wastewater main Flow.

3. The system of claim 2, wherein the filtration unit comprises at least one filtration pressure sensor, wherein the at least one controller is further in communication with the filtration unit and, if the at least one filtration pressure sensor measures a filtration pressure greater than a predefined filtration pressure threshold, the at least one controller is further configured to:
disable the wastewater main flow;
bypass the wastewater main flow directly to the equalization unit; or
when the filtering unit comprises two or more filters and a first filter has triggered the filtration pressure sensor, activate a redirecting valve configured to redirect the wastewater main flow to a second filter.

4. The system of claim 1, wherein the wastewater level sensor is an ultrasonic sensor configured to measure the instantaneous distance from the highest part of the at least one equalization tank to a wastewater surface inside said equalization tank, and wherein the equalization tank also includes:
at least one low level switch;
at least one medium level switch with high and low positions; and
at least one high level switch;
wherein the at least one controller is further configured to:
deactivate the first, second and/or third impulsion subunits if the low-level switch is activated;
enable the wastewater main flow from the wastewater source if the mid-level switch is activated in the low position;
disable the wastewater main flow from the wastewater source if the mid-level switch is activated in the high position; and
disable the wastewater main flow from the wastewater source if the high-level switch is activated.

5. The system of claim 1, wherein the mixing unit comprises at least one mixing line that is arranged close to a bottom of the at least one equalization tank, wherein the at least one mixing line comprises:
an extraction section, configured to extract the wastewater portion from the equalization unit by the first impulsion subunit;
a measurement and adjustment section, configured to measure and adjust parameters of the wastewater portion, wherein the measurement and adjustment section comprises the at least one pH sensor, the at least one TSS sensor, and the at least one additive injection location;
an aeration section, configured to introduce air to the wastewater portion and to obtain an aerated wastewater portion; and
an injection section, configured to deliver the aerated wastewater portion with adjusted parameters inside the at least one equalization tank.

6. The system of claim 5, wherein the first impulsion subunit is a mixing pump, the aeration section comprises a Venturi device configured to extract atmospheric air and the injection section comprises a distribution ring with mixing injectors within the at least one equalization tank, wherein the Venturi device and the mixing injectors are configured to mix and distribute the aerated wastewater portion with adjusted parameters within the at least one equalization pond and to add oxygen within the at least one equalization tank, obtaining the wastewater feed suitable for biofiltration.

7. The system of claim 5, wherein:
the predefined mixing operation times comprise activation and deactivation intervals of the first impulsion subunit, said activation and deactivation intervals being of between 7 to 30 minutes, preferably of 10 minutes;
when the at least one pH sensor measures a pH level lower than 5.5 or greater than 9, preferably lower than 6.0 or greater than 8.5, the at least one controller is further configured to:
activate the first impulsion subunit;
activate the injection of at least one pH regulating additive via the at least one additive injection location; and
deactivate the second impulsion subunit; and
when the at least one pH sensor measures a pH level within the range 5.5-9.0, preferably 6.0-8.5, the at least one controller is further configured to:
deactivate the injection of the at least one pH regulating additive; and
deactivate the first impulsion subunit with a predefined delay time, to ensure the mixing of the wastewater within the equalization unit with the wastewater portion with adjusted parameters, obtaining the wastewater feed suitable for biofiltration.

8. The system of claim 5, wherein the measurement and adjustment section comprises:
one or more additional sensors configured to measure electrical conductivity, temperature and/or pressure of the first impulsion subunit; and
additional additive injection locations configured to adjust parameters of the wastewater portion based on odor control and/or larvae and fly control, and/or to supplement bacteria to the biofiltration unit.

9. The system of claim 1, wherein the at least one additive source corresponds to at least one additive tank, wherein the at least one additive tank comprises a metering pump configured to inject the at least one additive by the at least one controller, wherein each additive tank comprises at least one additive level sensor configured to emit alerts regarding an amount of remaining additive.

10. The system of claim 1, wherein:
the second impulsion subunit corresponds to wastewater feed pumps which quantity and capacity are defined based on a wastewater feed surface of the biofiltration unit, including an additional wastewater feed pump in case of failure, wherein the at least one controller is also configured to activate a sequence of activating the wastewater feed pumps alternately for each wastewater feed cycle and based on the predefined wastewater feed operation times, the wastewater feed volume or the absolute value of solids;
the pumping unit comprises at least one wastewater feed pressure sensor downstream each wastewater feed pump, wherein the at least one controller is further configured to deactivate each wastewater feed pump if the at least one wastewater feed pressure sensor measures a wastewater feed pressure above a predefined wastewater feed pressure threshold;
the pumping unit comprises a manifold downstream the at least one wastewater feed pressure sensor, wherein the manifold is configured to unify the wastewater feed pressure before the biofiltration unit, the manifold comprises a wastewater feed inlet for each wastewater feed pump and one outlet; and
the at least one wastewater feed flowmeter of the pumping unit is arranged at the outlet of the manifold and upstream a wastewater feed line configured to deliver wastewater feed to the biofiltration unit.

11. The system of claim 10, wherein the at least one biofiltration bed comprises at least one moisture sensor, wherein the at least one controller is further in communication with the at least one moisture sensor and,
if a moisture level of the at least one biofiltration bed is greater than a predefined moisture upper threshold, the at least one controller is further configured to deactivate the at least one wastewater feed pump and/or to close a respective electrovalve, or
if a moisture level of the at least one biofiltration bed is lower than a predefined moisture lower threshold, the at least one controller is further configured to activate the at least one wastewater feed pump and/or to open a respective electrovalve.

12. The system of claim 1, wherein the biofiltration unit comprises two or more biofiltration beds, wherein the pumping unit comprises an independent wastewater feed line for each biofiltration bed, wherein each wastewater feed line comprises a wastewater feed pump and a respective electrovalve, wherein the at least one controller is further configured to operate the opening and closing of each electrovalve with a delay time on the activation or deactivation of the respective wastewater feed pump, based on the predefined wastewater feed operation times, the wastewater feed volume or the absolute value of solids.

13. The system of claim 1, wherein the predefined wastewater feed operation times and setpoints for the wastewater feed volume and the absolute value of solids are main control parameters defined and stored in the at least one controller for each biofiltration bed of the biofiltration unit, for each wastewater feed cycle and for a daily total.

14. The system of claim 1, wherein the equalization unit, the mixing unit, the pumping unit, the recirculation unit and the at least one controller are, at least in part, included within a housing named control unit, optionally, the control unit comprises a filtration unit upstream of the equalization unit.

15. The system of claim 14, wherein the control unit further comprises at least one fan and/or light arranged on a roof of the housing, insulation elements arranged on walls of the housing, at least one heating device and/or at least one access door.

16. A method for monitoring and control of wastewater biofiltration, integrated in a wastewater biofiltration method, characterized in that the wastewater biofiltration method comprises:
receiving, from a wastewater source, a wastewater main flow in an equalization unit downstream the wastewater source, wherein said equalization unit receives the wastewater main flow in a controllable manner and adjusts wastewater parameters obtaining a wastewater feed suitable for biofiltration, and wherein the equalization unit comprises at least one equalization tank comprising:
at least one wastewater inlet;
at least one wastewater feed outlet; and
at least one wastewater level sensor;
extracting a wastewater portion from the equalization unit by means of a mixing unit, wherein the mixing unit comprises:
a first impulsion subunit;
at least one pH sensor;
at least one Total Suspended Solids (TSS) sensor; and
at least one additive injection location for additive injection from at least one additive source;
measuring and adjusting parameters of the wastewater portion by the mixing unit;
delivering the wastewater portion with adjusted parameters to the equalization unit,
extracting, from the equalization unit, the wastewater feed by means of a pumping unit downstream the equalization unit, wherein the pumping unit comprises a second impulsion subunit and at least one wastewater feed flowmeter;
delivering the wastewater feed to at least one biofiltration bed of a biofiltration unit, initiating wastewater feed cycles;
receiving the wastewater feed in the biofiltration unit downstream the pumping unit, wherein said biofiltration unit biofilters the wastewater feed and delivers biofiltered wastewater;
receiving the biofiltered wastewater in a biofiltered wastewater discharge downstream the biofiltration unit;
extracting a portion of the biofiltered wastewater from the wastewater discharge by means of a recirculation unit, wherein the recirculation unit comprises at least one recirculation valve and/or a third impulsion subunit, and wherein the recirculation unit further comprises at least one recirculation flowmeter; and
delivering the biofiltered wastewater portion to the equalization unit;
wherein, by means of at least one controller in communication with the equalization, mixing, pumping and recirculation units, the method further comprises that the at least one controller:
enables or disables the input of the wastewater main flow to the equalization unit, by means of wastewater level data measured by the at least one wastewater level sensor;
operates the first impulsion subunit based on predefined mixing operation times or based on pH data of the wastewater portion measured by the at least one pH sensor of the mixing unit, wherein the predefined mixing operation times are stored in the at least one controller;
adjusts parameters of the wastewater portion extracted by the mixing unit, by the pH data and the operation of the at least one additive injection location;
operates the second impulsion subunit based on predefined wastewater feed operation times, a wastewater feed volume or an absolute value of solids, wherein the predefined wastewater feed operation times are stored in the at least one controller, the wastewater feed volume is obtained by the at least one wastewater feed flowmeter and the absolute value of solids is obtained by means of data from the at least one TSS sensor and the volume delivered by the at least one wastewater feed flowmeter; and
operates the at least one recirculation valve and/or the third impulsion subunit based on a predefined quantity of biofiltered wastewater to be recirculated to the equalization unit and recirculation volume measured by the at least one recirculation flowmeter.

17. The method of claim 16, further comprises removing suspended particles greater than a predefined size of suspended particles from the wastewater main flow, by means of a filtration unit upstream the equalization unit, wherein the filtration unit comprises at least one filter.

18. The method of claim 17, wherein the filtration unit comprises at least one filtration pressure sensor, wherein the at least one controller is further in communication with the filtration unit and, if the at least one filtration pressure sensor measures a filtration pressure greater than a predefined filtration pressure threshold, the method further comprises that the at least a controller:
disables the main wastewater flow;
bypasses the wastewater main flow directly to the equalization unit; or
when the filtering unit comprises two or more filters and a first filter has triggered the filtration pressure sensor, activates a redirecting valve that redirects the wastewater main flow to a second filter.

19. The method of claim 16, wherein the wastewater level sensor is an ultrasonic sensor that measures the instantaneous distance from the highest part of the at least one equalization tank to a wastewater surface inside said equalization tank, and wherein the equalization tank also includes:
at least one low level switch;
at least one medium level switch with high and low positions; and
at least one high level switch;
wherein the method further comprises that the at least one controller:
deactivates the first, second and/or third impulsion subunits if the low-level switch is activated;
enables the wastewater main flow from the wastewater source if the mid-level switch is activated in the low position;
disables the wastewater main flow from the wastewater source if the mid-level switch is activated in the high position; and
disables the wastewater main flow from the wastewater source if the high-level switch is activated.

20. The method of claim 16, wherein the mixing unit comprises at least one mixing line that is arranged close to a bottom of the at least one equalization tank, wherein:
extracting the wastewater portion from the equalization tank is carried out in an extraction section of the at least one mixing line, by the first impulsion subunit; and
measuring and adjusting parameters of the wastewater portion is carried out in a measurement and adjustment section of the at least one mixing line, wherein the measurement and adjustment section comprises the at least one pH sensor, the at least one TSS sensor and the at least one additive injection location;
wherein the method further comprises introducing air to the wastewater portion in an aeration section of the at least one mixing unit, obtaining an aerated wastewater portion; and
wherein delivering the portion of wastewater with adjusted parameters and aerated is carried out in an injection section inside the at least one equalization tank.

21. The method of claim 20, wherein the first impulsion subunit is a mixing pump, the aeration section comprises a Venturi device that extracts atmospheric air and the injection section comprises a distribution ring with mixing injectors within the at least one equalization tank, wherein by the Venturi device and the mixing injectors the method further comprises mixing and distributing the aerated wastewater portion with adjusted parameters within the at least one equalization tank and adding oxygen within the at least one equalization tank, obtaining the wastewater feed suitable for biofiltration.

22. The method of claim 20, wherein:
the predefined mixing operation times comprise activation and deactivation intervals of the first impulsion subunit, said activation and deactivation intervals being of between 7 to 13 minutes, preferably of 10 minutes;
when the at least one pH sensor measures a pH level lower than 5.5 or greater than 9-0, preferably lower than 6.0 or greater than 8.5, the method comprises that the at least one controller:
activates the first impulsion subunit;
activates the injection of at least one pH regulating additive via the at least one additive injection location; and
deactivates the second impulsion subunit; and
when the at least one pH sensor measures a pH level within the range 5.5-9.0, preferably 6.0-8.5, the method further comprises that the at least one controller:
deactivates the injection of the at least one pH regulating additive; and
deactivates the first impulsion subunit with a predefined delay time, to ensure the mixing of the wastewater within the equalization unit with the wastewater portion with adjusted parameters, obtaining the wastewater feed suitable for biofiltration.

23. The method of claim 20, wherein the measurement and adjustment section comprises:
one or more additional sensors configured to measure electrical conductivity, temperature and/or pressure of the first impulsion subunit; and
additional additive injection locations configured to adjust parameters of the wastewater portion based on odor control and/or larvae and fly control, and/or to supplement bacteria to the biofiltration unit.

24. The method of claim 16, wherein the at least one additive source corresponds to at least one additive tank, wherein the at least one additive tank comprises a metering pump that injects at least one additive by the at least one controller, wherein each additive tank comprises at least one additive level sensor that emits alerts regarding an amount of remaining additive.

25. The method of claim 16, wherein:
the second impulsion subunit corresponds to wastewater feed pumps which quantity and capacity are defined based on a wastewater feed surface of the biofiltration unit, including an additional wastewater feed pump in case of failure, wherein the method also includes that the at least one controller activates a sequence of activating the wastewater feed pumps alternately for each wastewater feed cycle and based on the predefined wastewater feed operation times, the wastewater feed volume or the absolute value of solids;
the pumping unit comprises at least one wastewater feed pressure sensor downstream each wastewater feed pump, wherein the method further comprises that the at least one controller deactivates each wastewater feed pump if the at least one wastewater feed pressure sensor measures a wastewater feed pressure greater than a predefined wastewater feed pressure threshold;
the pumping unit comprises a manifold downstream the at least one wastewater feed pressure sensor, wherein the method further comprises that the manifold unifies the pressure of the wastewater feed before the biofiltration unit, wherein the manifold comprises a wastewater feed inlet for each wastewater feed pump and an outlet; and
the at least one wastewater feed flowmeter of the pumping unit is arranged at the outlet of the manifold and upstream a wastewater feed line that delivers wastewater feed to the biofiltration unit.

26. The method of claim 25, wherein the at least one biofiltration bed comprises at least one moisture sensor, wherein the at least one controller is further in communication with the at least one moisture sensor and,
if a moisture level of the at least one biofiltration bed is greater than a predefined moisture upper threshold, the method further comprises that the at least one controller deactivates the at least one wastewater feed pump and/or closes a respective electrovalve, or
if a moisture level of the at least one biofiltration bed is lower than a predefined moisture lower threshold, the method further comprises that the at least one controller activates the at least one wastewater feed pump and/or opens a respective electrovalve.

27. The method of claim 16, wherein the biofiltration unit comprises two or more biofiltration beds, wherein the pumping unit comprises an independent wastewater feed line for each biofiltration bed, wherein each line of wastewater feed comprises a wastewater feed pump and a respective electrovalve, wherein the method further comprises that the at least one controller operates the opening and closing of each electrovalve with a delay time on the activation or deactivation of the respective wastewater feed pump, based on the predefined wastewater feed operation times, the wastewater feed volume or the absolute value of solids.

28. The method of claim 16, wherein the predefined wastewater feed operation times and setpoints for the wastewater feed volume and the absolute value of solids are main control parameters defined and stored in the at least one controller for each biofiltration bed of the biofiltration unit, for each wastewater feed cycle and for a daily total.

29. The method of claim 16, wherein the equalization unit, the mixing unit, the pumping unit, the recirculation unit and the at least one controller are, at least in part, included within a housing named control unit, optionally the control unit comprises a filtration unit upstream the equalization unit.

30. The method of claim 29, wherein the control unit further comprises at least one fan arranged on a roof of the housing, insulating elements arranged on walls of the housing, at least one heating device and/or at least one access door.
